(19) United States
(12) Patent Application Publication
(10) Pub. No.: US 2015/0278472 A1
(43) Pub. Date: Oct. 1, 2015

(54) SYSTEMS AND METHODS FOR COMMUNICATING FINANCIAL BENEFIT INFORMATION TO PATIENTS AND PRESCRIBERS FOR A MEDICATION PRESCRIBED DURING A PRESCRIPTION PROCESS

(71) Applicant: MCKESSON FINANCIAL HOLDINGS, HAMILTON (BM)

(72) Inventors: Brian King, Atlanta, GA (US); Elizabeth S. Kaye, Suwanee, GA (US); Allan Marks, Alpharetta, GA (US)

(73) Assignee: MCKESSON FINANCIAL HOLDINGS, HAMILTON (BM)

(21) Appl. No.: 14/226,689

(22) Filed: Mar. 26, 2014

(51) Int. Cl. G06F 19/00

(52) U.S. Cl. CPC G06F 19/3456

(57) ABSTRACT

Systems, methods are provided for communicating financial benefit information associated with an electronic prescription transaction submitted by a healthcare provider as part of the healthcare provider's medication selection process for a patient. The transaction may be received at a service provider computer from a healthcare provider computer and may include patient identification information and one or more identifiers for a product being prescribed to the patient. The service provider computer may identify a financial benefit provided for the product and may transmit the transaction, including the identified financial benefit for the product, to a pharmacy computer. The identified financial benefit for the product may alternatively and/or additionally be transmitted to a healthcare provider computer or a patient communication device.

### TECHNICAL FIELD

Aspects of the disclosure relate generally to financial benefits for medication and other healthcare products, and more particularly, to systems and methods for communication of financial benefit information to patients and prescribers for a medication prescribed during a prescription process.

### BACKGROUND

Physicians and patients are generally not aware of financial benefits that are available for a medication prior to prescribing the medication or other healthcare product. For example, vouchers, e-vouchers, coupons, and/or discounts may be available for particular medications, however, the physician may not be aware of the financial benefits associated with a particular medication and therefore may prescribe an alternative, more costly, medication that does not have a financial benefit associated with it. At times, without the incentive of a financial benefit, a patient may choose to not purchase the prescribed medication, often leading to a preventable worsening of the disease and/or illness associated with a patient diagnosis.

### BRIEF DESCRIPTION OF THE DRAWINGS

Reference will now be made to the accompanying drawings, which are not necessarily drawn to scale, and wherein:

FIG. 1 illustrates an example overview of a system that facilitates the communication of financial benefit information for a prescription by a healthcare provider during the course of a prescription process, according to one exemplary embodiment.

FIG. 2 is a block diagram of an example data flow for storing, accessing, and/or communicating financial benefit information for a prescription transaction communicated by a healthcare provider during the prescription process, according to one exemplary embodiment.

FIGS. 3A and 3B illustrate a flow chart of an example method for storing, accessing, and/or communicating financial benefit information for a prescription transaction communicated by a healthcare provider during the prescription process, according to one exemplary embodiment.

FIG. 4 illustrates a flow chart of an example method for receiving and storing financial benefit information, according to one exemplary embodiment.

FIG. 5 illustrates a flow chart of an example method for receiving and storing patient communication information, according to one exemplary embodiment.

FIG. 6 illustrates a flow chart of an example method for determining whether a patient is eligible to receive financial benefits for a prescription according to one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate the communication of financial benefit information for a prescription requested by a healthcare provider. The financial benefit information may be communicated to a pharmacy for communication to the healthcare provider (e.g., the pharmacist or any other employee of the pharmacy). For example, a prescription transaction communicated by a healthcare provider may be received and evaluated by a service provider computer prior, during, and/or subsequent to routing or otherwise communicating the prescription request to one or more of various pharmacy computers. In one example implementation, the service provider computer may determine if there are financial benefits for the medication identified in the prescription. The service provider computer may transmit determined financial benefits to a physician device and a patient communication device.

System Overview

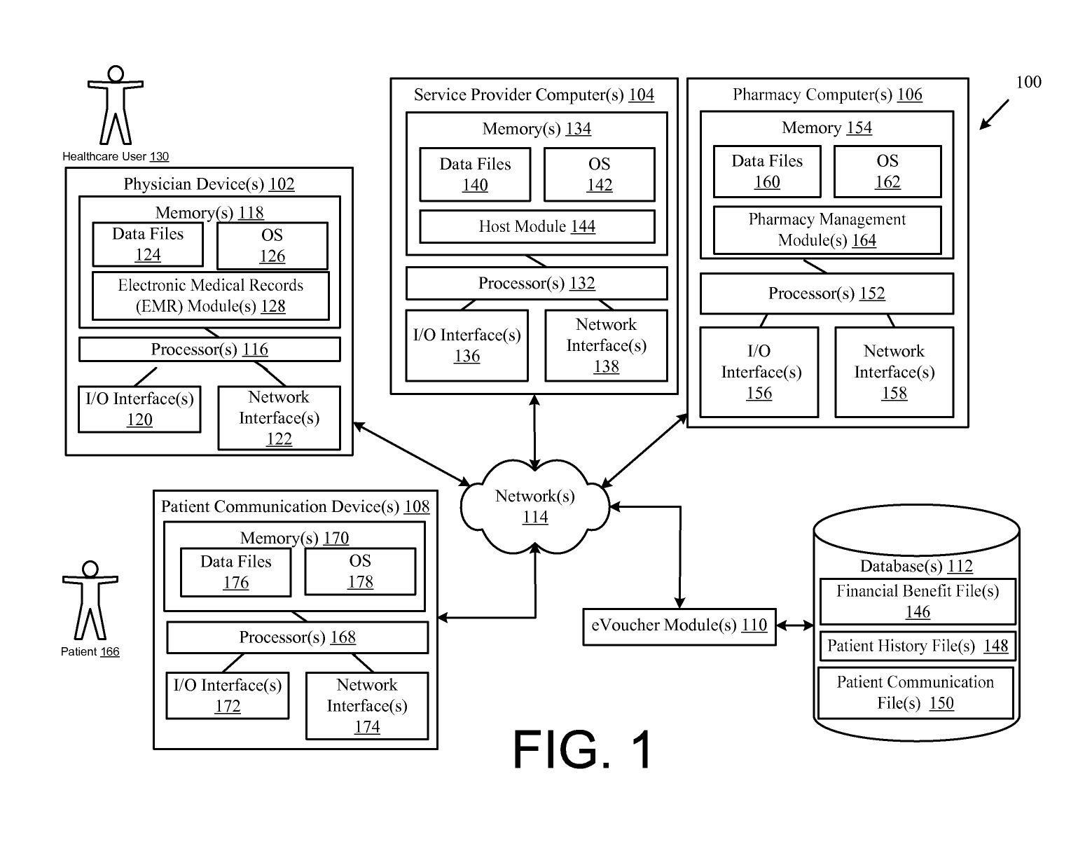

FIG. 1 illustrates an example system 100 for facilitating, among other things, the timely and efficient communication of financial benefit information for a prescription by a healthcare provider during the course of a prescription process (i.e., creation and fulfillment of electronic prescription order transaction, e-script, or e-prescription). As shown in FIG. 1, the system 100 may include one or more physician devices 102, service provider computers 104, pharmacy computers 106, and/or patient communication devices 108. As desired, each of the physician devices 102, service provider computers 104, pharmacy computers 106, and/or patient communication devices 108 may include one or more processing devices that may be configured for accessing and reading associated computer-readable media having stored data thereon and/or computer-executable instructions for implementing various embodiments of the disclosure.

The exemplary physician device 102 is not intended to be limited to physicians alone and may otherwise be associated with any healthcare provider, such as, for example, a prescriber (such as a physician's office, hospital, urgent care center, dentist, and/or nurse practitioner). While the exemplary healthcare provider computer 102 references a physician, this is for example only and is not intended to be limiting in any manner.

Additionally, in one or more example embodiments of the disclosure, the service provider computers 104 may include or otherwise be in communication with a eVoucher module 110 or eVoucher application, which may access and/or be in communication with one or more suitable databases and/or data storage devices 112. The eVoucher module 110 may access financial benefits for identified prescriptions or treatment selections made by a healthcare provider during the course of the prescription process (i.e., creating an electronic prescription order transaction, e-script, or e-prescription).

Generally, network devices and systems, including one or more of the physician devices 102, service provider computers 104, pharmacy computers 106, and/or patient communication devices 108, may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the physician device 102, service provider computer 104, pharmacy computer 106, and/or patient communication devices 108, may be in communication with each other via one or more networks, such as network 114, which may include one or more independent and/or shared private and/or public networks including the Internet or a publicly switched telephone network. In other example embodiments, one or more components of the system 100 may communicate via direct connections and/or communication links. Each of these components—the physician device 102, the service provider computer 104, the pharmacy computer 106, the patient communication device 108, and the network 114—will now be discussed in further detail. Although the components are generally discussed as singular components, as may be implemented in various example embodiments, in alternative exemplary embodiments each component may include any number of suitable computers and/or other components.

With continued reference to FIG. 1, one or more physician devices 102 may be associated with a healthcare provider, for example, a physician, a nurse, a nurse practitioner, a physician's assistant, a hospital, a physician's office, a dentist, etc. A physician device 102 may be any suitable processor-driven device that facilitates the processing of healthcare transactions made by or on behalf of physicians (e.g., requests to view patient history information, requests to view financial benefit information, requests to view prescription information, requests to view patient information, prescription transactions, etc.), the communication of healthcare transactions to the service provider computer 104, and/or the receipt, processing, and display of responses received from the service provider computer 104. For example, the physician device 102 may be a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. The physician device 102 having computer-executable instructions stored thereon may form a special-purpose computer or other particular machine that is operable to facilitate the processing of transactions/requests for healthcare information made by or on behalf of a healthcare provider and the communication of requested healthcare information and other healthcare transactions to the service provider computer 104. Additionally, in certain embodiments, the operations and/or control of the physician device 102 may be distributed among several processing components. In addition to including one or more processors 116, the physician device 102 may further include one or more memory devices (or memory) 118, one or more input/output (“I/O”) interfaces 120, and one or more network interfaces 122. The memory devices 118 may be any suitable memory devices, for example, caches, read-only memory devices, random access memory devices, magnetic storage devices, removable storage devices, etc. The memory devices 118 may store data, executable instructions, and/or various program modules utilized by the physician device 102, for example, data files 124, an operating system (“OS”) 126, and/or an electronic medical records (EMR) module 128.

The OS 126 may be a suitable software module that controls the general operation of the physician device 102. The OS 126 may also facilitate the execution of other software modules by the one or more processors 116, for example, the EMR module 128. The OS 126 may be any operating system known in the art or which may be developed in the future including, but not limited to, Microsoft Windows®, Apple OSX™, Apple iOS™, Google Android™, Linux, Unix, or a mainframe operating system.

The EMR module 128 may be a software application(s), including, but not limited to, a dedicated program: for making diagnoses; for determining prescription medications or products, over-the-counter medications, products or other healthcare services associated with one or more diagnoses; for creating prescription transactions (including e-prescription transactions (i.e., electronic prescription order transactions, e-scripts, or e-prescriptions)); for reading and/or updating medical records, etc., as well as interacting with the service provider computer 104. For example, a healthcare user 130, such as a physician and/or other healthcare provider or their employee, may utilize the EMR module 128 during a patient diagnosis process, for recording and/or updating medical records, and/or for preparing and providing a healthcare transaction (such as an e-prescription transaction (i.e., electronic prescription order transaction, e-script, or e-prescription)) to the service provider computer 104. Furthermore, the physician device 102 may utilize the EMR module 128 to retrieve or otherwise receive data, messages, or responses from the service provider computer 104 and/or other components of the system 100.

The one or more I/O interfaces 120 may facilitate communication between the physician device 102 and one or more input/output devices, for example, one or more user interface devices, such as a display, keypad, control panel, touch screen display, remote control, microphone, etc., that facilitate user interaction with the physician computer 102. For example, the one or more I/O interfaces 120 may facilitate entry of information associated with a healthcare transaction by a healthcare provider, such as a physician. The one or more network interfaces 122 may facilitate connection of the physician device 102 to one or more suitable networks, for example, the network 114 illustrated in FIG. 1. In this regard, the physician device 102 may receive and/or communicate information to other network components of the system 100, such as the service provider computer 104.

With continued reference to FIG. 1, one or more service provider computers 104 may be associated with a service provider. A service provider computer 104 may include, but is not limited to, any suitable processor-driven device that is configured for receiving, processing, and fulfilling healthcare transactions from the physician device 102 relating to prescription services (including e-prescription transactions (i.e., electronic prescription order transactions, e-scripts, or e-prescriptions)), benefits determinations, eligibility determinations, other healthcare requests and/or other activities. Any number of physician devices 102 and/or pharmacy computers 106 may be in communication with the service provider computer 104 as desired in various example embodiments.

The service provider computer 104 may include any number of special-purpose computers or other particular machines, application-specific integrated circuits, microcontrollers, personal computers, minicomputers, mainframe computers, servers, networked computers, and/or other processor-driven devices. In certain embodiments, the operations of the service provider computer 104 may be controlled by computer-executed or computer-implemented instructions that are executed by one or more processors associated with the service provider computer 104 to form a special-purpose computer or other particular machine that is operable to facilitate the receipt, routing, and/or processing of healthcare requests or healthcare transactions. The one or more processors that control the operations of the service provider computer 104 may be incorporated into the service provider computer 104 and/or may be in communication with the service provider computer 104 via one or more suitable networks. In certain example embodiments, the operations and/or control of the service provider computer 104 may be distributed among several processing components.

Similar to the physician device 102, the service provider computer 104 may include one or more processors 132, one or more memory devices 134, one or more input/output (“I/O”) interfaces 136, and one or more network interfaces 138. The one or more memory devices 134 may be any suitable memory device, for example, caches, read-only memory devices, etc. The one or more memory devices 134 may store data, executable instructions, and/or various program modules utilized by the service provider computer 104, for example, data files 140, an operating system (“OS”) 142, and/or a host module 144. The OS 142 may be any operating system known in the art or which may be developed in the future including, but not limited to, Microsoft Windows®, Apple OSX™, Apple iOS™ Google Android™, Linux, Unix, or a mainframe operating system. The OS 142 may be a suitable software module that controls the general operation of the service provider computer 104 and/or that facilitates the execution of other software modules.

According to an example embodiment, the data files 140 may store healthcare transaction records associated with communications received from various physician devices 102 and/or various pharmacy computers 106. The data files 140 may also store any number of suitable routing tables that facilitate determining the destination of communications received from or sent to a physician device 102, a pharmacy computer 106, or a patient communication device 108. In one or more example embodiments of the disclosure, the service provider computer 104 may include or otherwise be in communication with one or more financial benefit files 146 and/or prescription files 146 which may access and/or be in communication with one or more suitable databases and/or data storage devices 112. The financial benefit files 146 may contain, receive, and/or retrieve from medication and/or treatment/service information to facilitate the analysis of whether one or more medications have a corresponding financial benefit. In one example implementation, the financial benefit may include, without limitation, one or more prescription vouchers and/or coupons. Additionally, in one or more example embodiments of the disclosure, the service provider computer 104 may include or otherwise be in communication with one or more patient history files 148 or a patient history application which may access and/or be in communication with one or more suitable databases and/or data storage devices 112. The patient history file 148 may receive patient healthcare transaction information to facilitate the analysis of whether a patient meets the predetermined requirements to receive a financial benefit, such as a given prescription voucher and/or coupon. In one example embodiment, the patient history files 148 may include any type of patient information including but not limited to, patient last name, patient first name, patient address (including street address, city, state/province, and zip/postal code) patient age, patient gender, drug/product usage, and medications that patient is currently being prescribed.

Furthermore, in one or more example embodiments of the disclosure, the service provider computer 104 may include or otherwise be in communication with one or more patient communication files 150 or a patient communication application which may access and/or be in communication with one or more suitable databases and/or data storage devices 112. The patient communication files 150 may receive patient contact information to facilitate the communication of financial benefit, such as a given prescription voucher and/or coupon, to a patient. In one example embodiment, the patient communication files 150 may include any type of patient contact information including but not limited to, a patient identification number (such as, but not limited to, patient social security number, a subset of the patient social security number, health insurance claim number (HICN), cardholder ID, etc.), a patient last name, a patient first name, a patient address (including street address, city, state/province, and zip/postal code), a patient home phone number, a patient cellular phone number, a patient fax number, and/or a patient email address. Alternatively and/or additionally, patient communication information may be included in the patient history file 148.

The service provider computer 104 may include additional program modules for performing other processing methods described herein. Those of ordinary skill in the art will appreciate that the service provider computer 104 may include alternate and/or additional components, hardware, or software without departing from the scope of the disclosure.

An eVoucher module 110 may also be operative with the service provider computer 104. The eVoucher module 110 may include computer-executable instructions for facilitating, among other things, the timely and efficient communication of financial benefit information for an identified medication or other healthcare product in a prescription or a treatment selection made by a healthcare provider during the course of the prescription process (i.e., creating an e-prescription transaction (e.g., electronic prescription order transaction, e-script, or e-prescription)). As an example, the eVoucher module 110 may be operative to access drug product information (via, for example, National Drug Code (NDC) code, RxNorm code, medication name, etc.) stored or recorded in a financial benefit file 146. The eVoucher module 110 may utilize the information accessed in the financial benefit file 146 to determine whether a financial benefit associated with a medication or other healthcare product identified in a prescription and whether the financial benefit should be communicated to a physician device 102 and/or to a patient communication device 108. In one example implementation, the financial benefit may include, without limitation, co-pay savings/reduction, standard co-pay saving cards, or other discount cards such as a first fill free associated with a specific prescription for an illness/disease. The financial benefit may further include a fixed or percentage amount for a voucher, coupon, or discount available to the patient. In certain exemplary embodiments, the eVoucher module 110 may be implemented as computer-implemented instructions of the memory 134 of the service provider computer 104 or may otherwise be located within the service provider computer 104. Alternatively, the eVoucher module 110 may also be implemented as computer-implemented instructions of a memory of a separate computing entity or processor-based system, according to another example embodiment of the disclosure.

The service provider computer 104 may facilitate the storage of product information and financial information for a prescription in the financial benefit file 146. In one example implementation, the product information may include, without limitation, drug or service product information such as an NDC code (and/or, a RxNorm code, or a medication name, universal product code (UPC) or other unique product identifier and/or code), product labeler and/or brand name, a product trade name, a product type, a drug class, a list of active and inactive ingredients, a manufacturer associated with a product, dosage, and usage frequency associated with a product. Additionally, the service provider computer 104 may facilitate the storage of corresponding financial benefits information and any patient eligibility requirements in the financial benefit file 146. The financial benefits information for a drug product may be communicated to the service provider computer 104 from a manufacturer of a product, a marketer of the product, from the pharmacy computer 106, and/or from an interested third party. In certain example embodiments, the eVoucher module 110 may access the drug product information stored in the financial benefit file 146 to determine the availability of financial benefits for particular medications or healthcare services that may be communicated to the physician device 102 and/or to the patient communication device 108.

As a non-limiting example, the eVoucher module 110 may also access one or more patient history files 148 associated with a prescription. For example, one or more patient history files may include information associated with a drug and or product determined to be targeted by an associated financial benefit. In one example, the service provider computer 104 may determine what drug and/or product is associated with a financial benefit and whether a patient meets any or all eligibility requirements associated with the financial benefit; however, it is to be appreciated that the eVoucher module 110, physician device 102, and/or the pharmacy computer 106 may also determine such classifications. In one example, the product may be a medication targeting migraines, such as the product with NDC code 55111-0293. Continuing with the example, in an effort to grow share of a specific market, the manufacturer may provide the financial benefit for the medication when prescribed to female patients. The service provider computer 104 may access the one or more patient history files 148 and utilize the information to determine the gender (and optionally in addition the age) of the patient and based on that determination identify whether a patient is eligible for the medication. The one or more patient history files 148 may be organized by patient information (e.g., patient name and/or patient identifier). Alternatively, the one or more patient history files 148 may be organized by drug or product information (e.g., NDC code, RxNorm code, or other UPC code) or by information associated with a drug therapy and/or treatment.

The service provider computer 104 may also access one or more patient communication files 150 associated with a patient. In one example implementation, the service provider computer 104 may employ the eVoucher module 110 to access the one or more patient communication files 150 and determine whether the one or more patient communication files 150 includes a patient communication file including any patient contact information corresponding to an identified patient. The service provider computer 104 may utilize the information to communicate financial benefit information to the patient communication device 108.

With continued reference to the service provider computer 104, the one or more I/O interfaces 136 may facilitate communication between the service provider computer 104 and one or more input/output devices, for example, one or more user interface devices, such as a display, keypad, control panel, touch screen display, remote control, microphone, etc., that facilitate user interaction with the service provider computer 104. The one or more network interfaces 138 may facilitate connection of the service provider computer 104 to one or more suitable networks, for example, the network 114 illustrated in FIG. 1. In this regard, the service provider computer 104 may communicate with other components of the system 100.

With continued reference to FIG. 1, any number of pharmacy computers 106 may be associated with any number of pharmacies and/or pharmacists. Each pharmacy computer 106 may be any suitable processor-driven device that facilitates receiving, processing, and/or fulfilling healthcare transactions and/or prescription transactions received from the service provider computers 104. For example, a pharmacy computer 106 may be a processor-driven device associated with (i.e., located within) a pharmacy. As desired, the pharmacy computer 106 may include any number of special-purpose computers or other particular machines, application-specific integrated circuits, microcontrollers, personal computers, minicomputers, mainframe computers, servers, and the like. In certain example embodiments, the operations of the pharmacy computer 106 may be controlled by computer-executed or computer-implemented instructions that are executed by one or more processors associated with the pharmacy computer 106 to form a special-purpose computer or other particular machine that is operable to facilitate the receipt, processing, and/or fulfillment of healthcare transactions (e.g., a prescription claim or billing request, healthcare order transaction, or e-prescription transaction (i.e., electronic prescription order transaction, e-script, or e-prescription)) received from the service provider computer 104. The one or more processors that control the operations of a pharmacy computer 106 may be incorporated into the pharmacy computer 106 and/or may be in communication with the pharmacy computer 106 via one or more suitable networks. In certain example embodiments, the operations and/or control of the pharmacy computer 106 may be distributed among several processing components.

Similar to other components of the system 100, each pharmacy computer 106 may include one or more processors 152, one or more memory device 154, one or more I/O interfaces 156, and one or more network interfaces 158. The one or more memory devices 154 may be any suitable memory devices, for example, caches, read-only memory device, random access memory devices, magnetic storage devices, removable memory devices, etc. The one or more memory devices 154 may store data, executable instructions, and/or various program modules utilized by the pharmacy computer 106, for example, data files 160, an OS 162, and a pharmacy management module 164. The data files 160 may include any suitable information that is utilized by the pharmacy computer 106. The OS 162 may be a suitable software module that controls the general operation of the pharmacy computer 106. The OS 162 may also facilitate the execution of other software modules by the one or more processors 152. The OS 162 may be any operating system known in the art or which may be developed in the future including, but not limited to, Microsoft Windows®, Apple OSX™ Apple iOS™, Google Android™, Linux, Unix, or a mainframe operating system.

The one or more I/O interfaces 156 may facilitate communication between the pharmacy computer 106 and one or more input/output devices, for example, one or more user interface devices, such as a display, keypad, control panel, touch screen display, remote control, microphone, etc., that facilitate user interaction with the pharmacy computer 106. The one or more network interfaces 158 may facilitate connection of the pharmacy computer 106 to one or more suitable networks, for example, the network 114 illustrated in FIG. 1. In this regard, the pharmacy 106 may receive healthcare transactions and/or other communications from the service provider computer 104 and the pharmacy computer 106 may communicate information associated with processing healthcare transactions to the service provider computer 104.

The pharmacy management module 164 may be a software application(s), including a dedicated program, for fulfilling healthcare transaction orders, reading and/or updating medical records (e.g., prescription records), facilitating patient billing, etc., as well as interacting with the service provider computer 104. For example, a pharmacist or other pharmacy employee, may utilize the pharmacy management module 164 in filling a prescription for a medication or other healthcare product or service, recording and/or updating a patient's medical prescription history, billing a patient, and preparing and providing a healthcare transaction response to the service provider computer 104.

With continued reference to FIG. 1, any number of patient communication device(s) 108 may be associated with any number of patients 166. Each patient communication device 108 may be any suitable processor-driven device that facilitates receiving communications from any communication device including the physician devices 102, the service provider computers 104, and/or the pharmacy computers 106. As desired, the patient communication device 108 may include one or more of a personal computer, a laptop computer, a tablet computer, a mobile telephone, a portable digital assistant (PDA), an electronic book reader, a television, a set-top box, a game console, a facsimile, and/or the like. In certain example embodiments, the operations of the patient communication device 108 may be controlled by computer-executed or computer-implemented instructions that are executed by one or more processors associated with the patient communication device 108 to form a special-purpose computer or other particular machine that is operable to facilitate communication with other sources.

Similar to other components of the system 100, each patient communication device 108 may include one or more processors 168, one or more memory devices 170, one or more I/O interfaces 172, and one or more network interfaces 174. The one or more memory devices 170 may be any suitable memory devices, for example, caches, read-only memory device, random access memory devices, magnetic storage devices, removable memory devices, etc. The one or more memory devices 170 may store data, executable instructions, and/or various program modules utilized by the patient communication device 108, for example, data files 176 and an OS 178. The data files 176 may include any suitable information that is utilized by the patient communication device 108. The OS 178 may be a suitable software module that controls the general operation of the patient communication device 108. The OS 178 may also facilitate the execution of other software modules by the one or more processors 168. The OS 178 may be any operating system known in the art or which may be developed in the future including, but not limited to, Microsoft Windows®, Apple OSX™, Apple iOS™, Google Android™, Linux, Unix, or a mainframe operating system.

The one or more I/O interfaces 178 may facilitate communication between the patient communication device 108 and one or more input/output devices, for example, one or more user interface devices, such as a display, keypad, control panel, touch screen display, remote control, microphone, printer, etc., that facilitate user interaction with the patient communication device 108. The one or more network interfaces 174 may facilitate connection of the patient communication device 108 to one or more suitable networks, for example, the network 114 illustrated in FIG. 1 or a cellular phone network. In this regard, the patient communication device 108 may receive financial benefit information and/or other communications from physician device 102, the service provider computer 104, and/or the pharmacy computer 106. While the patient communication device 108 is described herein as a processor-driven device (i.e., a personal computer, a laptop computer, a tablet computer, a mobile telephone, a portable digital assistant (PDA), etc.), it is to be appreciated that the patient communication device 108 may also include any suitable non-processor-driven devices. For example, a non-processor-driven device may include, without limitation, a landline telephone (i.e., a main line, a home phone, a landline, a fixed-line, and the like) fixed in a home of the patient.

The network 114 may include any telecommunication and/or data network, whether public, private, or a combination thereof, including a local area network, a wide area network, an intranet, the Internet, intermediate handheld data transfer devices, and/or any combination thereof and may be wired and/or wireless, or any combination thereof. The network 114 may also allow for real time, offline, and/or batch transactions to be transmitted between or among the physician device 102, the service provider computer 104, and the pharmacy computer 106. Various methodologies as described herein, may be practiced in the context of distributed computing environments. Although the service provider computer 104 is shown for simplicity as being in communication with the physician device 102 or the pharmacy computer 106 via one intervening network 114, it is to be understood that any other network configurations are possible. For example, intervening network 114 may include a plurality of networks, each with devices such as gateways and routers for providing connectivity between or among the components of the system 100. Instead of or in addition to the network 114, dedicated communication links may be used to connect various devices in accordance with an example embodiment. For example, the service provider computer 104 may form the basis of network 114 that interconnects the physician device 102 and the pharmacy computer 106.

Those of ordinary skill in the art will appreciate that the system 100 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the service provider computer 104 (or other computer) may be implemented as a specialized processing machine that includes hardware and/or software for performing the methods described herein. In addition, at least a portion of the processor 132 and/or the processing capabilities of the service provider computer 104 and/or the eVoucher module 110, may be implemented as part of a pharmacy computer 106. Accordingly, embodiments of the disclosure should not be construed as being limited to any particular operating environment, system architecture, or device or network configuration.

Operational Overview

Certain portions of the exemplary methods below will be described with reference to the communication of a financial benefit associated with a prescription as part of the prescription process (e.g., a medication or other healthcare product or service selection transaction, electronic prescription transaction (i.e., electronic prescription order transaction, e-script, or e-prescription); however, this is only for purposes of example as other healthcare transactions (which may include, for example, a predetermination of benefits request; a prescription claim or billing request, or healthcare order transaction) could be substituted. While the methods described below are in reference to a prescription transaction, each form of healthcare transaction should each individually be read as being used in the methods described below.

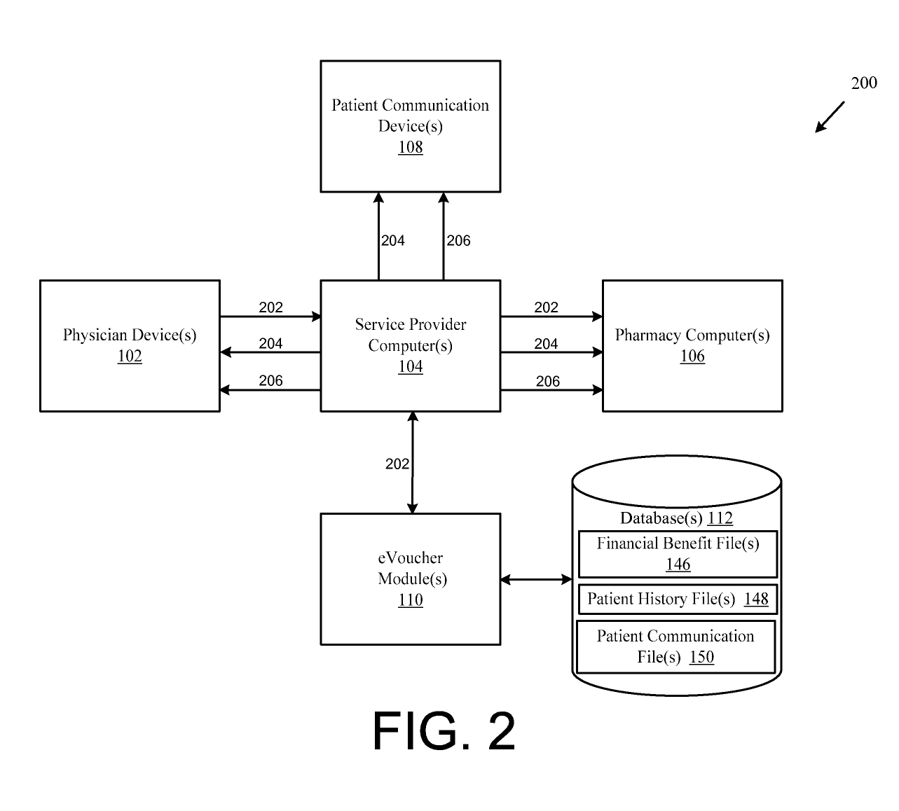

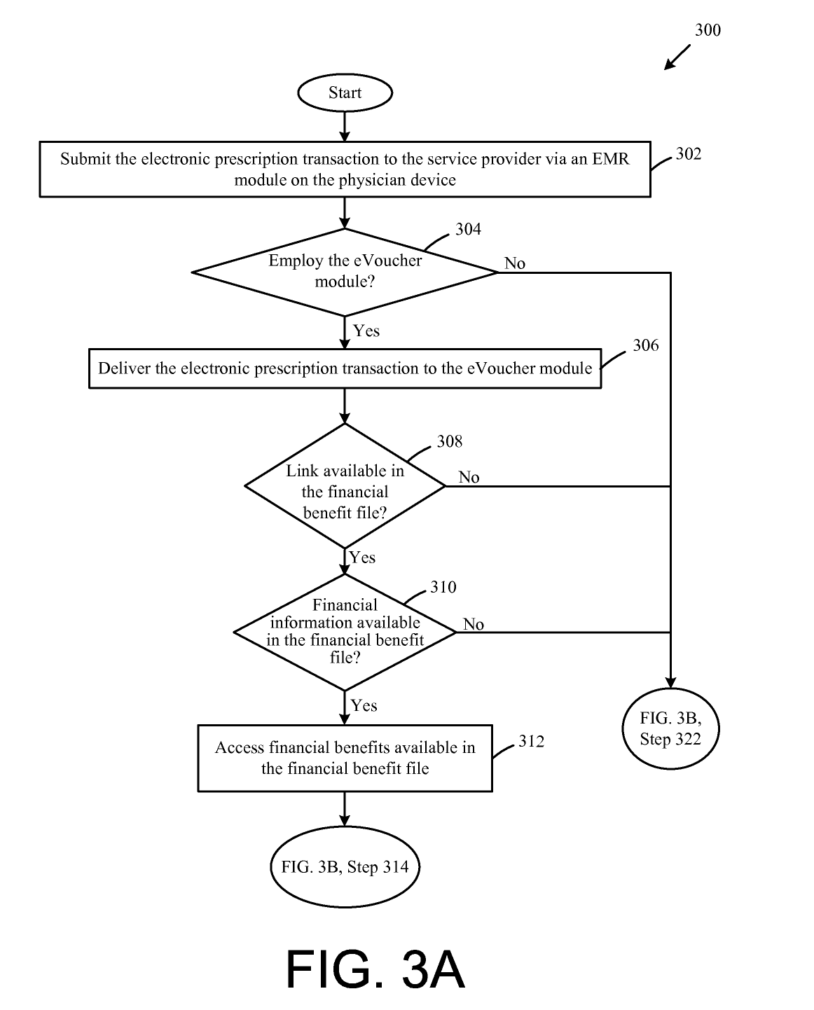

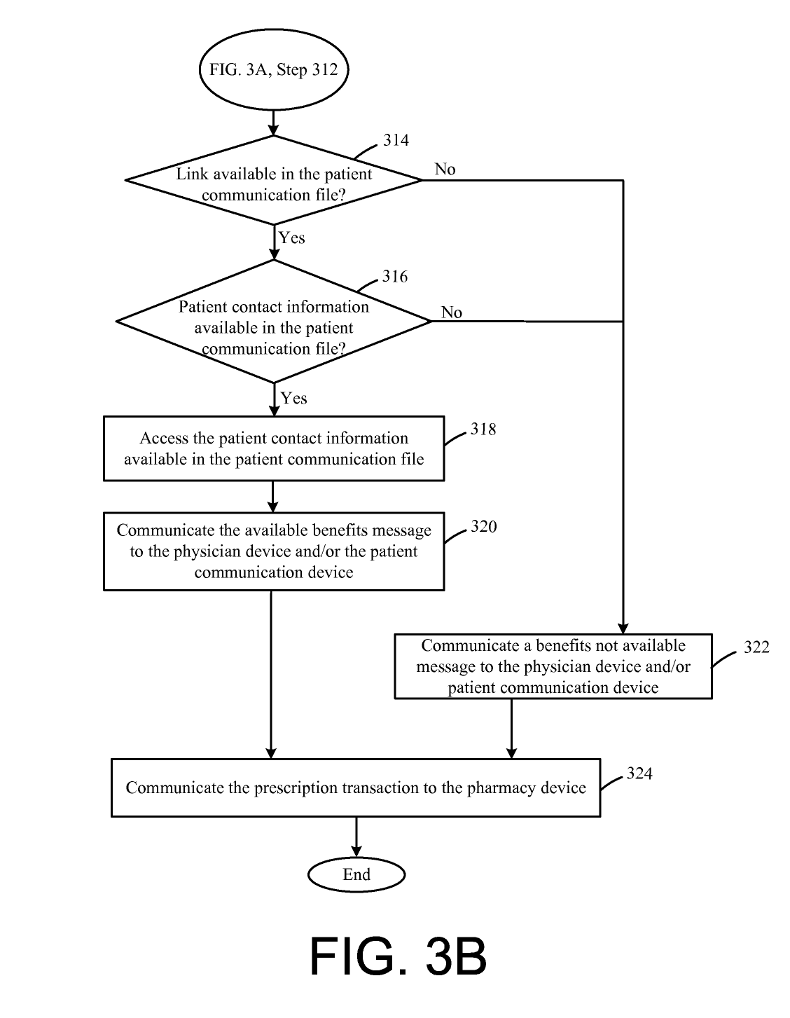

FIG. 2 illustrates an example block diagram for storing, accessing, and/or communicating financial benefit information for a prescription submitted by a healthcare provider during a prescription process, according to an example embodiment of the disclosure. FIGS. 3A and 3B illustrate an example method 300 for storing, accessing, and/or communicating financial benefit information for a prescription transaction submitted by a healthcare provider during the preparation of a prescription transaction, according to an example embodiment of the disclosure. The block diagram 200 of FIG. 2 will be discussed in conjunction with the method 300 of FIGS. 3A and 3B.

Referring now to FIGS. 1, 3A and 3B, the exemplary method 300 begins at the START step and continues to step 302, where the physician device, such as the physician device 102, may be utilized to submit a prescription transaction 202 to the service provider computer 104, where the prescription transaction 202 includes a medication/treatment selected by a healthcare provider during the preparation of the prescription transaction. In one example implementation, the prescription transaction 202 may be submitted to the service provider 104 to determine financial benefit information available for communication to the physician device 102, the pharmacy computer 106, and/or the patient communication device 108.

In one example implementation, the EMR module 128 may facilitate a selection of a medication/treatment in response to a patient diagnosis and prepare the prescription transaction 202 to include the selected medication/treatment. The EMR module 128 may further communicate the prescription transaction 202, including the medication/treatment selection, to the service provider computer 104. For example, a healthcare provider, such as a physician, may utilize the EMR module 128 of the physician device 102 to select a diagnosis code associated with a patient diagnosis. Upon selection of the diagnosis code, the EMR module 128 may display multiple treatment options (e.g., drug therapy or service therapy) available to treat the diagnosed illness, injury, and/or disease. Utilizing the EMR module 128, the healthcare provider may select a medication/treatment option (e.g., a drug product (medication) and/or healthcare service) and submit that selection via prescription transaction 202 to the service provider computer 104. In one example implementation, the medication selection may be represented by an NDC code, a RxNorm code, a product name, an active ingredient name associated with a medication, and/or a drug product classification. For example, a patient may be diagnosed as suffering from migraines. A diagnosis code may be selected by the healthcare provider that identifies this diagnosis. Following the selection of the diagnosis code, the healthcare provider may be presented with treatments options (e.g., medications or other healthcare products or services) that may include at least a drug product represented by NDC 55111-0293 (RDY 293 (Sumatriptan 100 mg)), used for the treatment of migraines. While the examples presented herein refer to the NDC code, it is to be appreciated that a coding system may be any coding system used and recognized within the healthcare community. The prescription transaction 202 may be in accordance with a version of a National Council for Prescription Drug Programs (NCPDP) Telecommunication Standard, although other standards may be utilized as well. As an example, the prescription transaction may include one or more the following information:
Name (e.g. Patient Last Name, Patient First Name, etc.)
Date of Birth of Patient
Age of Patient
Patient Gender Code
Patient Address (e.g. Street Address, City, State/Province, Zip Code, etc.)
Patient Contact Information (e.g. patient telephone number, email address, etc.)
Patient Health Condition Information (e.g., pregnant)
Patient Identification Number (such as, but not limited to, patient social security number, a subset of the patient social security number, health insurance claim number (HICN), cardholder ID, etc.)

### Insurance/Coverage Information

Cardholder Name (e.g. Cardholder First Name, Cardholder Last Name)
Cardholder ID and/or other identifier (e.g. person code)
Group ID and/or Group Information

### Prescriber Information

Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code, NCPDP Provider ID, ePrescribing ID or other unique pharmacy and/or healthcare provider identifier)

### Claim Information

Drug, service, or product information (e.g., product identifier (via NDC code, RxNorm code, UPC, or other unique product/medication identifier)
Prescription/Service Reference Number
Date Prescription Written
Quantity
Days' Supply
Diagnosis/Condition
Number of Refills Authorized
One or more Drug Utilization (DUR) Codes
Date of Service.

The prescription transaction 202 may be communicated to the service provider computer 104 via one or more suitable networks 114 (e.g., a wide area network, the Internet, a cellular network, etc.). The service provider computer 104 may parse the received prescription transaction 202 to identify a pharmacy identifier (i.e., National Provider ID (NPI), a National Council for Prescription Drug Programs (NCPDP) Provider ID, or ePrescribing identifier, a pharmacy name, a pharmacy chain identifier, or any other suitable/unique pharmacy identifier) in one or more fields of the prescription transaction 202. The service provider computer 104 may further identify a destination of the prescription transaction 202 (e.g., based on the Banking Identification Number (BIN Number), the BIN Number and Processor Control Number (PCN) or the BIN Number and Group ID in one or more fields of the prescription transaction 202). In addition, the service provider computer 104 can conduct any pre-edits, as necessary, on the prescription.

At step 304, the service provider computer 104 may determine whether to employ an eVoucher module 110. In one example implementation, the determination may be based, at least in part, on information included in the prescription transaction 202. For example, the service provider computer 104 may parse the prescription transaction 202 to determine whether the request includes prescription information, such as the medication/treatment selection identified in the prescription transaction 202 or if the transaction code in the transaction is identified as one for which the eVoucher module should be employed. For example, the service provider computer 104 may parse the prescription transaction 202 to identify a medication/treatment selection in one or more predetermined fields of the transaction. The medication/treatment selection may include, without limitation, a drug identifier (e.g., NDC code, RxNorm code, other UPC code, etc.), a product name, an active ingredient name associated with a medication, and/or a drug product classification. If a medication treatment selection is identified in prescription transaction 202, then the YES branch is followed and processing may proceed to step 306. If a medication/treatment is not identified in prescription transaction 202, then the NO branch is followed and processing may proceed to step 322.

At step 306, the service provider computer 104 may route or deliver the prescription transaction 202 to the eVoucher module 110. In example embodiments where the eVoucher module 110 is a part of the service provider computer 104 or otherwise affiliated with the service provider computer 104, the delivery of the prescription transaction 202 may be an internal delivery or an intra-network delivery. However, where the eVoucher module 110 is a processor-based system distinct from the service provider computer 104, the delivery of the prescription transaction 202 may be an external delivery, for example, via the network 114, according to an example embodiment of the disclosure.

At step 308, the service provider computer 104 may determine whether a financial benefit file 146 includes a link to the medication/treatment selection identified in the prescription transaction 202. In one example implementation, the service provider computer 104 may employ the eVoucher module 110 to access the financial benefit file 146 and compare the medication/treatment selection identified in the prescription transaction 202 (e.g., utilizing an NDC code, a RxNorm, or other UPC) with one or more lists and/or tables stored in the financial benefit file 146. For example, the identified medication treatment selection may include, without limitation, a drug identifier, such as an NDC code. The service provider computer 104 may employ the eVoucher module 110 to compare the drug code identified in the prescription transaction 202 to a schedule, listing, or table of drug codes in the financial benefit file 146 to determine if a match exists, and determine whether there is financial benefit information associated with one or more of the matching drug codes in the financial benefit file 146.

In one example implementation, if a match is found, one or more links may be determined between the medication/treatment selection identified in the prescription transaction 202 and information (e.g, a drug identifier) located in at least one of a drug code table and/or listing, a product name table and/or listing, and/or a drug product classification table and/or listing stored in the financial benefit file 146. For example, the medication/treatment selection identified in the prescription transaction 202 may include, without limitation, an NDC code, such as NDC 55111-0293. A search of the financial benefit file 146 may determine that an NDC 55111-0293 reference exists in a financial benefit file including a drug code table made up of multiple NDC codes. As such, a link may be established between the medication/treatment identified in the prescription transaction 202 (NDC 55111-0293) and the drug code table including the NDC 55111-0293 stored in the financial benefit file 146. If the service provider computer 104 determines that the financial benefit file 146 includes at least one match between the medication/treatment selection identified in the prescription transaction 202 and information stored in the financial benefit file 146, the YES branch is followed and the process may proceed to step 310. However, if the service provider computer 104 determines that there are no matches between the medication/treatment selection identified in the prescription transaction 202 and information stored in the financial benefit file 146, then the NO branch is followed and processing may proceed to step 322.

At step 310, the service provider 104 may determine whether the link established at step 308 includes financial benefit information for the medication/treatment identified in the prescription transaction 202. In one example implementation, the service provider computer 104 may employ the eVoucher module 110 to search the linked file for one or more available vouchers, coupons, and/or discounts available to the patient. If the service provider computer 104 determines that financial benefit information is available for the medication/treatment identified in the prescription transaction 202, the YES branch is followed and the process may proceed to step 312. However, if the service provider computer 104 determines that financial benefit information is not available for the medication/treatment identified in the prescription transaction 202, then the NO branch is followed and processing may proceed to step 322.

At step 312, the service provider computer 104 may access the financial benefits available in the financial benefit file 146 for the medication/treatment identified in the prescription transaction 202 (e.g., coupons, vouchers, co-pay reductions, standard co-pay saving cards, or other discount and/or discount cards, such as a first fill free associated with a specific prescription selection).

At step 314, the service provider computer 104 may determine whether patient contact information is associated with prescription transaction 202. In one example implementation, the service provider computer 104 may employ the eVoucher module 110 to compare patient identification information identified in the prescription transaction 202 to a schedule, listing, or table of patient contact information in the patient communication file 150 to determine if a match exists, and determine whether there is patient contact information associated with one or more of the matching patient identifiers in the patient communication file 150.

In one example implementation, if a match is found, one or more links may be determined between the patient identified in the prescription transaction 202 and information (e.g, a patient identifier) located in at least one of a patient table and/or listing stored in the patient communication file 150. For example, the patient identified in the prescription transaction 202 may include, without limitation, a social security number, such as SS#123-45-6789. A search of the patient communication file 150 may determine that an SS#123-45-6789 reference exists in a patient communication file including a patient table made up of multiple social security numbers. As such, a link may be established between the patient identified in the prescription transaction 202 (SS#123-45-6789) and the patient table including the SS#123-45-6789 stored in the patient communication file 150. If the service provider computer 104 determines that the patient communication file 150 includes at least one match between the patient identified in the prescription transaction 202 and information stored in the patient communication file 150, the YES branch is followed and the process may proceed to step 316. However, if the service provider computer 104 determines that the patient communication file 150 does not include at least one match between the patient identified in the prescription transaction 202 and information stored in the patient communication file 150, the NO branch is followed and the process may proceed to step 320.

At step 316, the service provider 104 may determine whether the link established at step 314 includes patient contact information for the patient identified in the prescription transaction 202. In one example implementation, the service provider computer 104 may employ the eVoucher module 110 to search the linked file for one or more patient home phone numbers, patient cellular phone numbers, patient fax numbers and/or patient email addresses. If the service provider computer 104 determines that patient contact information is available for the patient identified in the prescription transaction 202, the YES branch is followed and the process may proceed to step 318. However, if the service provider computer 104 determines that financial benefit information is not available for the medication/treatment identified in the prescription transaction 202, then the NO branch is followed and processing may proceed to step 320.

At step 318, the service provider computer 104 may access the contact information available in the patient communication file 150 for the patient identified in the prescription transaction 202 (e.g., patient home phone numbers, patient cellular phone numbers, patient fax numbers and/or patient email addresses).

At step 320, the service provider computer 104 may communicate an available benefits message 204 to the physician device 102 and/or the patient communication device 108 via phone call, internet message, text message, text message, email, fax, and/or any other available communication means. In one example implementation, the available benefits message 204 may include, without limitation, the financial benefits available in the financial benefit file 146 for the medication/treatment identified in the prescription transaction 202. If more than one link was determined at step 308, the available benefits message 204 may include a listing of financial benefit information available for the medication/treatment identified in the prescription transaction 202. The financial benefit information included in the available benefits message 204 may be used to reduce a patient's financial responsibility for the prescription. For example, the available benefits message 204 may include, without limitation, the availability of co-pay savings/reductions, standard co-pay saving cards, or other discount and/or discount cards such as a first fill free associated with a specific medication/treatment identified in the prescription transaction 202. Alternatively, the heath care provider may forward the financial benefits information to the patient. For example, the service provider computer 105 may communicate the available benefits message 204 to the physician device 102. The physician device 102 may access patient information and notify the patient of financial benefit information included in the available benefits message 204. If however, there is no financial information available in the financial benefit file 146 for the medication/treatment identified in the prescription transaction 202, at step 322 the service provider computer 104 may transmit a benefits not available message 206 including, without limitation, the prescription information identified in the prescription transaction 202 at step 302 as well as an indication of the absence of financial benefits associated with the medication or other healthcare product or service identified in the prescription transaction 202 to the physician device 102, the pharmacy computer 106, and/or the patient communication device 108 via, for example, the network 114.

At step 324, the service provider computer may transmit the prescription transaction 202 to the pharmacy computer 106. In one example implementation, the prescription transaction 202 may include the available benefits message 204, which may include, without limitation, the financial benefits available in the financial benefit file 146 for the medication/treatment identified in the prescription transaction 202.

The process may end after step 324.

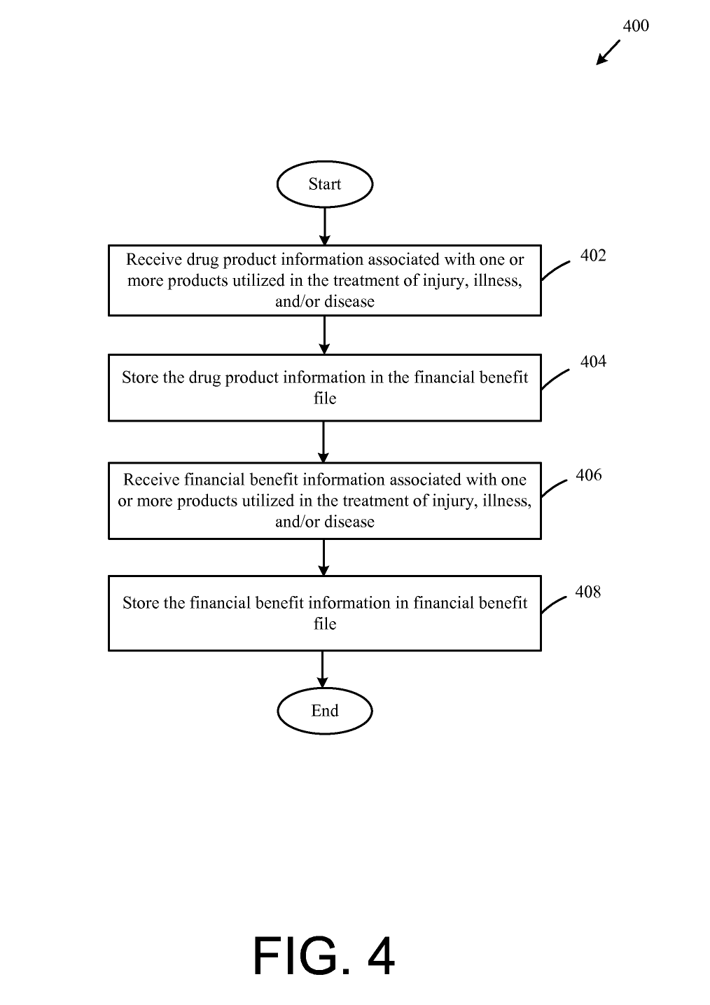

FIG. 4 illustrates an example method 400 for receipt and storage of financial benefit information associated with one or more products (e.g., medications or other healthcare products) and/or services utilized in the treatment of an injury, illness, and/or disease in accordance with one example embodiment. In one non-limiting example, the operations of the method 400 may be performed by the service provider computer 104 illustrated in FIG. 1.

Now referring to FIGS. 1 and 4, the exemplary method 400 begins at the START step and proceeds to step 402, where the service provider computer 104 may receive drug product information associated with one or more products utilized in the treatment of an injury, illness, and/or disease. The drug product information may be communicated to the service provider computer 104 from a manufacturer of a product, from the pharmacy computer 106, from a marketer of the product, and/or from a regulatory agency (e.g., the Food & Drug Administration (FDA)) and may include, without limitation, at least one NDC code, a product name, an active ingredient name for an active ingredient included in the medication, and/or a drug product classification.

At step 404, the service provider computer 104 may store the received drug product information in the financial benefit file 146. The financial benefit file 146 may be organized such that the eVoucher module 110 may access the information contained within the financial benefit file 146 when making a determination whether financial benefit information is available for a prescription transaction (as discussed herein). In one example implementation, the financial benefit file 146 may include one or more listing(s) and/or table(s) including drug codes (e.g., NDC code), product names, an active ingredient name for an active ingredient included in the medication and/or drug product classifications. The service provider computer 104 may employ the eVoucher module 110 to access the financial benefit file 146 and compare any medication/treatment selections identified in the prescription transaction 202 to one or more of the table(s) and/or listing(s).

Turning to step 406, the service provider computer 104 may receive financial benefit information for products for which product information was received at step 402. The financial benefit information may be communicated to the service provider computer 104 from a manufacturer, a supplier, a marketer of a product, and/or the like. In one example implementation, financial benefit information may be in the form of an electronic voucher, coupon, co-pay reduction, standard co-pay saving card, or other discount and/or discount cards, such as a first fill free associated with a specific prescription selection or product or other discounts that can be utilized by or provided for the benefit of the patient.

At step 408, the service provider computer 104 may store the financial benefit information in the financial benefit file 146. The financial benefit file 146 may be organized such that the eVoucher module 110 may access the information contained within the financial benefit file 146 when making a determination whether financial benefit information is available for a medication or other healthcare product or service selected in a prescription selection (as discussed herein). In one example implementation, the financial benefit file 146 may include one or more links between the financial benefit information and one or more listing(s) and/or table(s) of data that include, without limitation drug codes, product names, drug product classifications, an active ingredient name for an active ingredient included in the medication, and/or any other relationship deemed appropriate. For example, the manufacturer of the anti-migraine medication identified by the NDC code 55111-0293 may provide a financial benefit that offsets/pays any patient co-pay responsibility in an effort to grow a market share. Continuing with the example, the financial benefit may be associated in the financial benefit file 146 by the NDC code 55111-0293, the product name Sumatriptan, the drug class “anti-migraine”, and/or any other appropriate characteristic.

Method 400 may end after step 404 or after step 408.

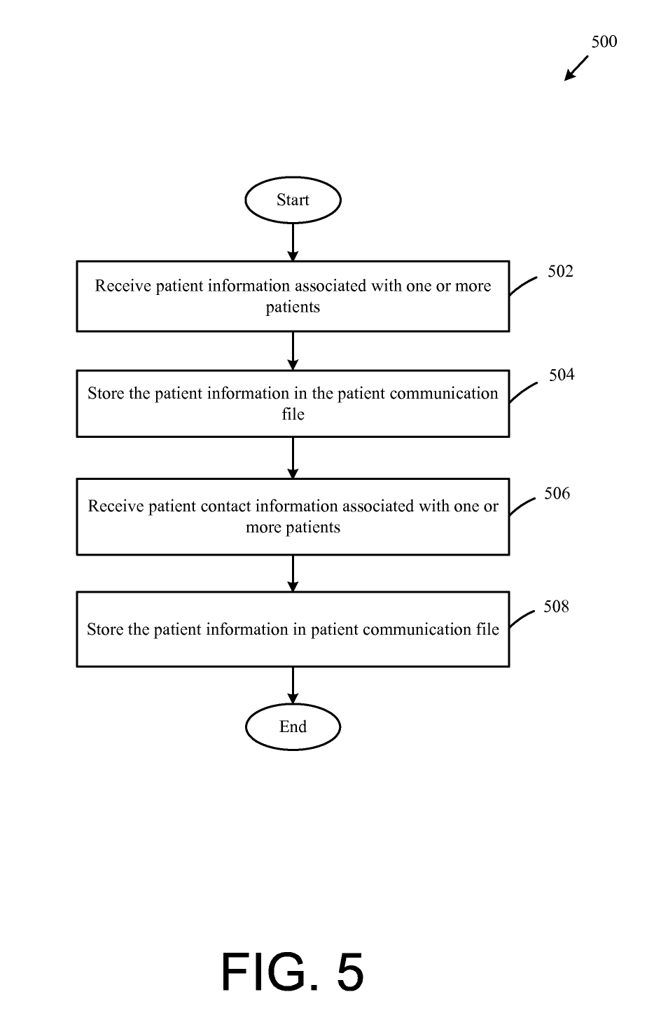

FIG. 5 illustrates an example method 500 for receipt and storage of patient communication information associated with one or more in accordance with one example embodiment. In one non-limiting example, the operations of the method 500 may be performed by the service provider computer 104 illustrated in FIG. 1.

Now referring to FIGS. 1 and 5, the exemplary method 500 begins at the START step and proceeds to step 502, where the service provider computer 104 may receive patient information associated with one or more patients. The patient information may be communicated to the service provider computer 104 from the physician device 102, from the pharmacy computer 106, from a claims adjudicator, and/or from a patient and may include, without limitation, at least one patient identification number (such as, but not limited to, patient social security number, a subset of the patient social security number, health insurance claim number (HICN), cardholder ID, etc.), a patient's last name, a patient's first name, a patient's address (including street address, city, state/province, and zip/postal code), and/or a patient's gender.

At step 504, the service provider computer 104 may facilitate storage of the received patient information in a patient communication file 150 (and/or in a patient history file 148). The patient communication file 150 may be organized such that the eVoucher module 110 may access the information included within the patient communication file 150 when making a determination whether patient contact information is available for a prescription transaction (as discussed herein). In one example implementation, the patient communication file 150 may include one or more listing(s) and/or table(s) including a patient identification number (such as, but not limited to, patient social security number, a subset of the patient social security number, health insurance claim number (HICN), cardholder ID, etc.), a patient last name, a patient first name, a patient address (including street address, city, state/province, and zip/postal code), and/or a patient gender. The service provider computer 104 may employ the eVoucher module 110 to access the patient communication file 150 and compare any patients identified in the prescription transaction 202 to one or more of the table(s) and/or listing(s).

Turning to step 506, the service provider computer 104 may receive patient contact information for patients for which product information was received at step 502. The patient contact information may be communicated to the service provider computer 104 from the physician device 102, from the pharmacy computer 106, from a claims adjudicator, and/or from a patient and may include, without limitation, at least one patient home phone number, patient cellular phone number, patient fax number, and/or patient email address

At step 508, the service provider computer 104 may store the patient contact information in the patient communication file 150. The patient communication file 150 may be organized such that the eVoucher module 110 may access the information contained within the patient communication file 150 when making a determination whether patient contact information is available for a patient in a prescription selection (as discussed herein). In one example implementation, the patient communication file 150 may include one or more links between the patient contact information and the one or more patient identification listing(s) and/or table(s). For example, the health care provider for the patient identified by the social security number (SS#) 123-45-6789 may provide a patient cellular phone number and patient email address. Continuing with the example, the patient contact information may be associated in the patient communication file 150 by the SS#123-45-6789, the patient's name, and/or any other appropriate characteristic.

Method 500 may end after step 504 or after step 508.

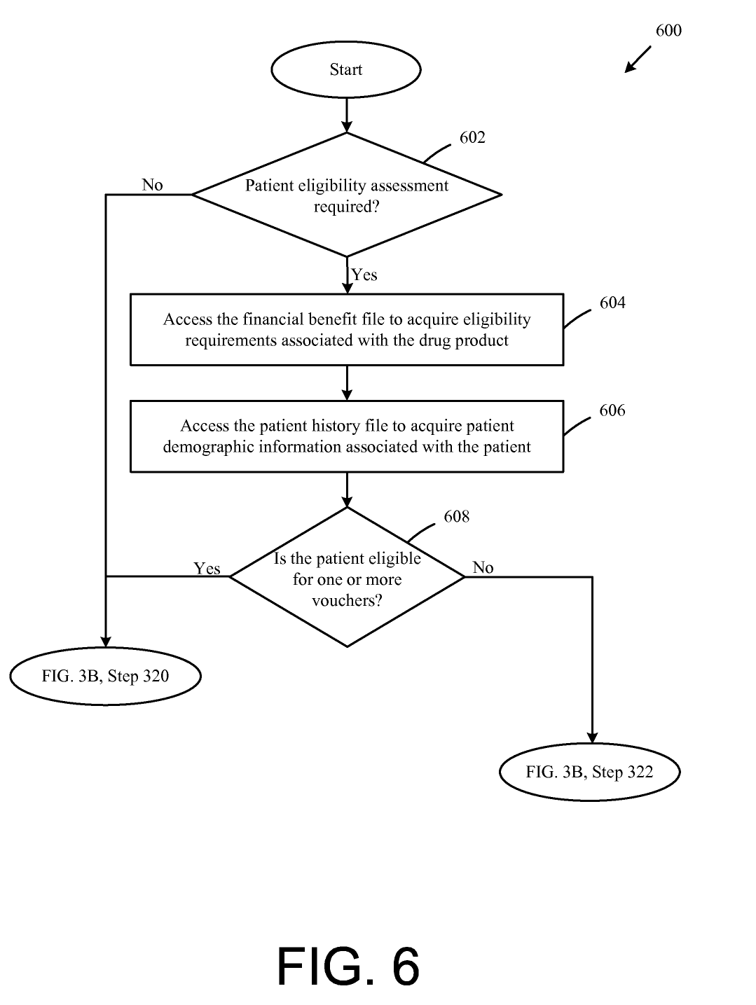

FIG. 6 illustrates an example method 700 for determining whether a patient is eligible to receive financial benefits for an identified medication/treatment selection in a prescription request transaction according to one exemplary embodiment. In one non-limiting example, the operations of the method 600 may be performed following step 318 of FIG. 3B by the service provider computer 104 illustrated in FIG. 1.

Now referring to FIGS. 1 and 6, the exemplary method 600 proceeds to step 602, where the service provider computer 104 may employ the eVoucher module 110 to determine whether a patient eligibility assessment is required for the patient to be eligible to receive an identified financial benefit. For example if the medication/treatment selection identified in the prescription transaction 202 includes at least NDC 55111-0293 and it has been determined that there is a financial benefit associated with NDC 55111-0293 in the financial benefit file 146, the eVoucher module 110 may determine whether the patient must satisfy one or more patient eligibility criteria in order to be eligible to receive the financial benefit. If the service provider computer 104 determines that the patient must satisfy one or more criteria in order to be eligible to receive the financial benefit, the YES branch is followed and the process may proceed to step 604. If the service provider computer 104 determines that the patient does not need to satisfy one or more criteria in order to be eligible to receive the financial benefit, the NO branch is followed and the process may proceed to FIG. 3B, step 320.

At step 604, the service provider computer 104 may employ the eVoucher module 110 to access the financial benefit information file 146 to access the one or more patient eligibility criteria required to receive the financial benefit associated with the medication/treatment selection identified in the prescription transaction 202 or an identified alternate medication/treatment. In one example implementation, the patient eligibility criteria may include, without limitation, patient gender, usage history, age requirement, patient health condition, zip/postal code, state, country, area code, other patient demographic information, or the like. At step 606, the service provider computer 104 may employ the eVoucher module 110 to access the demographic and medical history information for the patient identified in the prescription transaction. The demographic and medical history information for the identified patient may be stored in the patient history file 148 or may be retrieved from the received prescription transaction. For example, the demographic and medical history information may include gender, medication usage history, patient address (any one or more of: street, city state/province, zip/postal code), medical conditions for the patient, patient age, or the like.

At step 608, the service provider computer 104 may employ the eVoucher module 110 to compare patient demographic information accessed at step 606 with the patient eligibility criteria identified at step 604. In one, non-limiting example, the manufacturer of the migraine medication with the NDC code 55111-0293 may provide financial benefits to a specific market segment in an effort to grow share of that segment. Continuing with the example, the manufacturer may specify that only female patients are eligible to receive the financial benefit. Similarly, the marketer of a product may specify that only patients living in a certain portion of the country (e.g., by state, city, or zip/postal code) are eligible to receive a financial benefit. If the service provider computer 104 determines, based at least in part on the patient demographic information, that the patient identified in the prescription transaction 202 meets relevant patient eligibility requirements for one or more financial benefits, the YES branch is followed and the process may proceed to FIG. 3B, step 320. If the service provider computer 104 determines, based at least in part on the patient demographic information, that the patient does not meet relevant eligibility requirements, then the NO branch is followed and the process may proceed to FIG. 3B, step 322.

Various block and/or flow diagrams of systems, methods, apparatus, and/or computer program products according to example embodiments of the disclosure are described above. It will be understood that one or more blocks of the block diagrams and steps of the flow diagrams, and combinations of blocks in the block diagrams and combinations of steps in the flow diagrams, respectively, can be implemented by computer-executable program instructions. Likewise, some blocks of the block diagrams and steps of the flow diagrams may not necessarily need to be performed in the order presented, or may not necessarily need to be performed at all, according to some embodiments.

These computer-executable program instructions may be loaded onto a special-purpose computer or other particular machine, one or more processors, or other programmable data processing apparatus to produce a particular machine, such that the instructions that execute on the computer, processor, or other programmable data processing apparatus create means for implementing one or more functions specified in the flow diagram step or steps. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram step or steps. As an example, various embodiments of the disclosure may provide for a computer program product including a computer-usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and steps of the flow diagrams support combinations of means for performing the specified functions, combinations of elements or steps for performing the specified functions, and program instruction means for performing the specified functions. It will also be understood that each block of the block diagrams and step of the flow diagrams, and combinations of blocks in the block diagrams and steps of the flow diagrams, can be implemented by special-purpose, hardware-based computer systems that perform the specified functions, elements or steps, or combinations of special-purpose hardware and computer instructions.

Many modifications and other embodiments of the disclosure set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method, comprising:
receiving, from a healthcare provider computer associated with a healthcare provider, an electronic prescription transaction, wherein the electronic prescription transaction comprises patient information identifying a patient and a product identifier identifying a product being prescribed;
identifying, based at least in part on the product identifier, whether at least one financial benefit is provided for the product;
determining, based at least in part on the patient identifier, whether patient contact information associated with the patient identifier is available;
transmitting the identified available benefits message to a patient communication device associated with the available patient contact information, the identified available benefits message including the identified financial benefit for the product, the patient information identifying the patient, and the product identifier identifying the product,
wherein the above operations are performed by one or more computers associated with a service provider.

2. The computer-implemented method of claim 1 further comprising:
transmitting the identified available benefits message to the healthcare provider computer associated with the healthcare provider.

3. The computer-implemented method of claim 1 further comprising:
identifying a pharmacy computer identifier included in the electronic prescription transaction; and
transmitting the electronic prescription transaction and the identified available benefits message to the identified pharmacy computer.

4. The computer-implemented method of claim 3, wherein the pharmacy computer identifier is at least one of a National Provider ID (NPI), a National Council for Prescription Drug Programs (NCPDP) Provider ID, ePrescribing identifier or other unique pharmacy computer identifier.

5. The method of claim 1, wherein identifying whether a financial benefit is provided for a prescription comprises:
comparing the product identifier associated with the product with a plurality of stored product identifiers to identify at least one match; and
for each matching stored product identifier, identifying a financial benefit associated with the stored product identifier.

6. The method of claim 1 further comprising the step of facilitating the storage of financial benefit information associated with one or more products in one or more financial benefit files, the financial benefit information comprising at least one of a drug identifier, a product name, an electronic voucher, a coupon, or a discount.

7. The method of claim 1 further comprising the step of facilitating the storage of patient contact information associated with one or more patients in one or more patient communication files, the patient contact information comprising at least one of a patient home phone number, a patient cellular phone number, a patient fax number, and/or a patient email address.

8. The method of claim 1, wherein the patient contact information is identified by comparing the patient information identifying the patient in the electronic prescription transaction with one or more patient identifiers stored in a patient communication file, wherein each patient identifier stored in the patient communication file is associated with at least one means of patient contact information.

9. The method of claim 1, wherein the financial benefit is identified by comparing a product identifier identifying the product with one or more product identifiers stored in a financial benefit file, wherein each product identifier stored in the financial benefit file is associated with at least one financial benefit.

10. The method of claim 1, wherein the product identifier is a National Drug Code (NDC), and the NDC code is compared with one or more NDC codes stored in one or more drug code tables stored in a financial benefit file.

11. The method of claim 1, wherein the financial benefit includes at least one of a co-pay savings, a standard co-pay savings card, a discount associated with a first fill of a prescription product free, a voucher, an e-voucher, or a discount for purchasing an extended prescription product supply.

12. The method of claim 1 further comprising the steps of:
accessing a financial benefit file associated with the product;
determining, based upon information included in the financial benefit file, one or more patient eligibility requirements that must be satisfied by the patient identified in the prescription to receive the financial benefit for the product;
accessing one or more patient history files for the patient identified in the prescription request; and
determining, based at least in part on information included in the one or more patient history files, that the patient satisfies the one or more eligibility requirements to receive the financial benefit for the product.

13. A system comprising:
at least one memory operable to store computer-executable instructions; and
at least one processor configured to access the at least one memory and execute the computer-executable instructions to:
receive, from a healthcare provider computer associated with a healthcare provider, an electronic prescription transaction, wherein the electronic prescription transaction comprises patient information identifying a patient and a product identifier identifying a product;
identify, based at least in part on the product identifier, if at least one financial benefit is provided for the product;
determine, based at least in part on the patient identifier, whether patient contact information associated with the patient identifier is available;
direct communication of an available benefits message to a patient communication device associated with the available patient contact information, the available benefits message including the identified financial benefit for the product, the patient information identifying the patient, and the product identifier identifying the product.

14. The system of claim 13, wherein the at least one processor is further configured to access the at least one memory and execute the computer-executable instructions to:
direct communication of the identified available benefits message to the healthcare provider computer associated with the healthcare provider.

15. The system of claim 14, wherein the at least one processor is further configured to access the at least one memory and execute the computer-executable instructions to:
identify a pharmacy computer identifier included in the electronic prescription transaction; and
direct communication of the electronic prescription transaction and the identified available benefits message to the identified pharmacy computer.

16. The system of claim 15, wherein the pharmacy computer identifier is at least one of a National Provider ID (NPI), a National Council for Prescription Drug Programs (NCPDP) Provider ID, ePrescribing identifier or other unique pharmacy computer identifier.

17. The system of claim 13, wherein the at least one processor is further configured to access the at least one memory and execute the computer-executable instructions to identify if a financial benefit is provided for a product comprises:
comparing the product identifier associated with the product with a plurality of stored product identifiers to identify at least one match; and
for each matching stored product identifier, identifying a financial benefit associated with the stored product identifier.

18. The system of claim 13, wherein the patient contact information is identified by comparing the patient information identifying the patient in the electronic prescription transaction with one or more patient identifiers stored in a patient communication file, wherein each patient identifier stored in the patient communication file is associated with at least one means of patient contact information.

19. The system of claim 13, wherein the financial benefit is identified by comparing a product identifier identifying the product with one or more product identifiers stored in a financial benefit file, wherein each product identifier stored in the financial benefit file is associated with at least one financial benefit.

20. The system of claim 11, wherein the at least one processor is further configured to access the at least one memory and execute the computer-executable instructions to:
access a financial benefit file associated with the product;
determine, based upon based upon information included in the financial benefit file, one or more patient eligibility requirements that must be satisfied by the patient identified in the prescription to receive the financial benefit;
access one or more patient history files for the patient identified in the prescription; and
determine, based at least in part on information included in the one or more patient history files, that the patient satisfies the one or more eligibility requirements to receive the financial benefit.
